(19) United States
(12) Patent Application Publication
(10) Pub. No.: US 2007/0267883 A1
(43) Pub. Date: Nov. 22, 2007

(54) Titling Vehicle Frame

(75) Inventor: Been Yen Tsai, Taipei city (TW)

Correspondence Address: Lin Ching Hsieh, No.12, Lane 4, Dapu St. Wanhua District, Taipei city, TW, 108, US

(73) Assignee: GRAVITITECH LLC, Newark, CA (US)

(21) Appl. No.: 11/419,210

(22) Filed: May 19, 2006

(51) Int. Cl. B60J 9/00

(52) U.S. Cl. 296/1.01

(57) ABSTRACT

Separate vehicle into two parts, both could be suffer from the force of centrifugal, and shifting outward to the direction of centrifugal force. However, because of these two parts are connected into together as two opposite sides of a seesaw by rods means and pivots means, after push and pull with each other, only the part with larger momentum shift outward, the other part suffer from the momentum transfer from the tie rods means, has to shift inward. From proper setting, could gain the shape of tilting inward. Hence, the major advantage is without any hydraulic or electric system to tilt, could reach the cost down, better fuel efficiency, larger space and maintenance free benefits.

### BACKGROUND

1. Field of Invention

Normal four wheels car, provides the transportation with safety and shield from rain and cool wind. However, compare with motorbike, normal car without efficiency of fuel and when running on curve, will tilting outward which do not fit the demand of human body—tilting inward.

Motorbike, provide the inward tilting shape when running on curve and efficiency fuel demand. The defects are not shield human body from raining or winding weather and low safety degree.

Therefore, try to combine the excellent elements of motorbike and car into one object, as follows:
1. Shield from rain and wind.
2. Better safety degree then motorbike,
3. Better efficiency of fuel then car when setup as three wheels vehicle.
4. Tilting inward to fit the demand of human body.

Commonly, call this tilting vehicle.

2. Prior Art

In the field of tilting vehicle, the power to produce the force to tilt, commonly has two kinds:
1. Human power: Human body has to leaning inward to the center of curve, similar as riding a bicycle, to balance the force of centrifugal.
For example, the Honda Gyro, a three wheels motorbike, which carry delicious noodle or sushi around Japanese cities.
The defects are:
   a. Without the experience of riding a bike, could be turn over when running on curve.
   b. The weight of vehicle limited to light weight.
2. Artificial power: Typical products are Carver from Van Den Brink and Life-jet F-300 from Mercedes Benz. Both were perfect combination of electric equipments, hydraulic systems and mechanics.
But they still have some defects:
   a. The cost of electric and hydraulic systems are very expensive, it cause the price can not cheap enough to popular market.
   b. The electric and hydraulic systems spend too much space and weight of the vehicle, could not reach the high efficiency result.
   c. Electric and hydraulic systems do not mean without any errors, damages or maintenances.

### OBJECTS AND ADVANTAGES

Present invention cooperates with the centrifugal force to tilt, compare with the others which fight against with the centrifugal force.

That means, using the centrifugal force as the energy to tilt. From this, present invention gets benefits as follows:
1. Do not need any expensive hydraulic system and electric system—Cost down.
2. The hydraulic system and electric system spend too much space, save that for passengers and cargoes—Space larger.
3. Without the expensive hydraulic system and electric system, the weight down—Fuel efficiency is better.
4. Centrifugal force comes from the Mother Nature, without any maintenances or errors as electric system could be.—Maintenance free.

### BRIEF DESCRIPTION OF THE DRAWING

FIG. 1 is a schematic view of present tilting vehicle frame.

FIG. 2 is a sectional view of a bus which running on a curve.

FIG. 3 is a geometric drawing shows a pendulum structure.

FIG. 4 is a geometric drawing shows a seesaw structure.

FIG. 5 is a front or rear view of present tilting vehicle frame.

FIG. 6 is a front or rear view of present tilting vehicle frame has the geometric drawing combine with.

FIG. 7 is a left or right side view of present tilting vehicle frame for three wheels vehicle.

### DETAILED DESCRIPTION—PREFERRED EMBODIMENTS

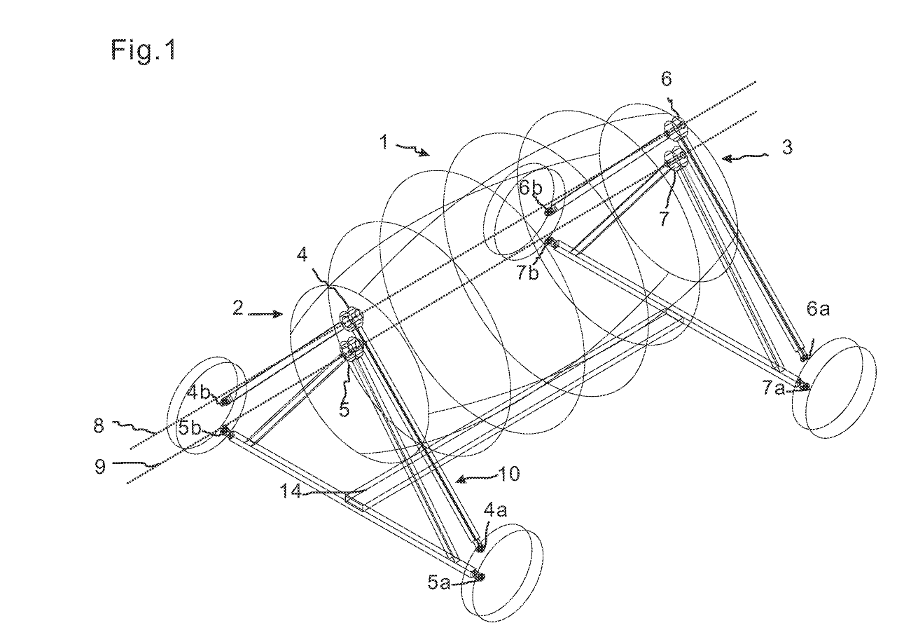

As shows on FIG. 1, a tilting vehicle frame, comprise as, a sub-frame 1, with a front and a rear side 2,3, both sides have at least two pivots (4, 5) (6, 7), a main-frame 10, has the same number of pivots means (4a, 4b) (5a, 5b) (6a, 6b) (7a, 7b), relative to the front or rear side of the sub-frame, parallel to each steering system or suspension system or any other structure which support the wheel, respectively.

Each pivot of the sub-frame 4,5,6,7 connect with each relative pivot (4a, 4b) (5a, 5b) (6a, 6b) (7a, 7b), which install at the wheel system or suspension system or any other structure which support the wheel, in constant structure. For example, the pivot 4 of sub-frame has to connect with the pivot 4a and the pivot 4b of main-frame in constant structure.

Please forgive me about the explanation of the physical methods, to eliminate the confusion of readers, as follow:

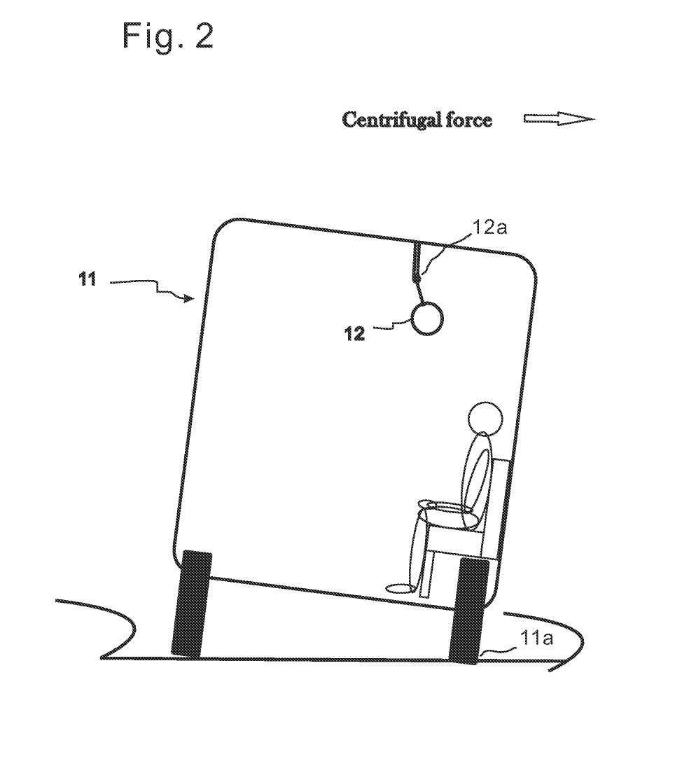

As shows in FIG. 2, a bus 11 will running on a curve with a strap hanger 12 inside. When suffer from the push of centrifugal force, the centre of mass of the bus move outward.

The strap hanger 12, also, suffers from centrifugal force, the center of mass move outward. However, the shapes of these two objects are different.

The bus 11 has the shape of tilting outward; the strap hanger 12 has the shape of tilting inward. Why?

This is because, when the bus 11 suffers from the centrifugal force, the center of mass is above the pivot of the bus 11a; however, the strap hanger 12 has its centre of mass below the pivot of strap hanger 12a.

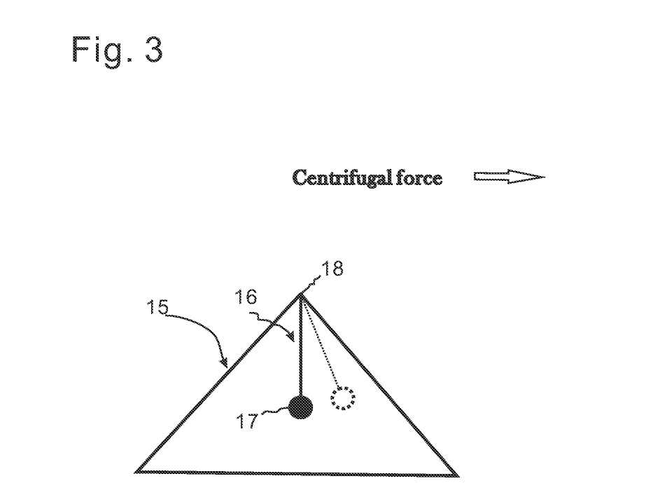

Therefore, as shows on FIG. 3, a geometric drawing, pretend a vehicle as a pendulum means, separate the vehicle into two parts, just like the bus 11 and the strap hanger 12 of FIG. 2, a main-frame 15, the part which contact with the ground, a sub-frame 16, the part which hanging on the main-frame, via a pivot 18 to support a mass 17 at the lower end.

When centrifugal force acting, indeed, the mass 17 tilting outward, as shows by dotted line, with the shape of human who running on curve, the defects are:
1. Centre of mass shifting too far away, cause the vehicle easily to turn over.
2. The sub-frame will continue swing, like a pendulum, when centrifugal force is zero.

For example, US Published Patent 20030102176, Title: Vehicle with a stabilized tilting sections, an excellent three wheeler invention, however, to avoid the over shifting of the center of mass, engineer has to setup a really wide width.

To solve the problem of over shifting and pendulum phenomena, need some object(s) for opposite action, that means, when the sub-frame shifting it's centre of mass, we need some other object(s) to do the opposite action, to reduce (balance) the over shifting of the center of mass, and reduce the pendulum phenomena.

Except the sub-frame which hangs on there, the only object is the main-frame.

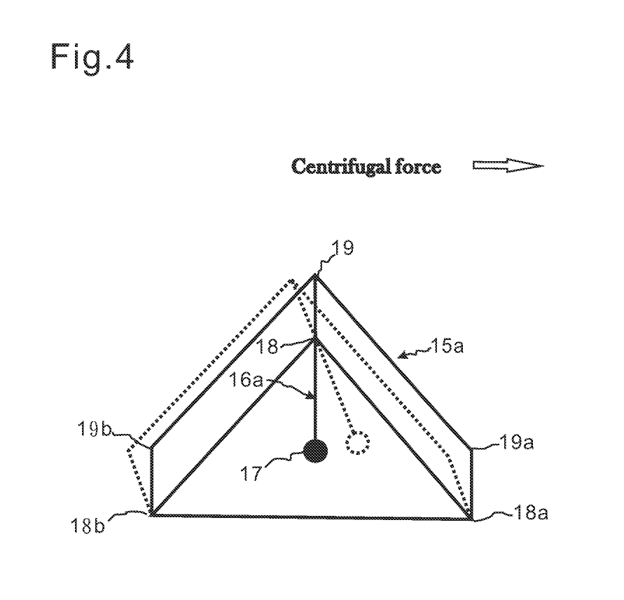

Inventor use a simple way to solve this problem, a seesaw, as shows on FIG. 4, a geometric drawing, pretend a vehicle frame as a seesaw, extend a sub-frame 16a from the pivot 18 to a pivot 19, four pivots 18, 19, 18a, 19a connected together into a square in the right side, the pivots 18, 19, 18b, 19b connected together into another square at the left side.

When centrifugal force is acting, the pivot 18 will become a pivot of a seesaw. Whenever the momentum of the part below the pivot 18 larger then the momentum of the part above the pivot 18, the whole structure becomes a shape of nature running human body—tilting inward, which will shows as dotted lines on FIG. 4. Yet, the shape only, the center of mass of whole structure will still moving outward. The benefits are reduce the over shifting of the center of mass to reasonable and safety range, and reduce the pendulum phenomena.

Whenever the centrifugal force become to zero, the mass 17 suffer from the pull of gravity, it will be back to the center, gently.

In other words, this invention separate vehicle into two parts, both could be suffer from the force of centrifugal and shifting outward to the direction of centrifugal force.

However, because of these two parts are connected into together as two opposite sides of a seesaw via rods means and pivots means, after push and pull with each other, only the part with larger momentum could shifting outward, another part suffer from the momentum transfer from the rods, has to shifting inward.

However, the geometric drawing of FIG. 4 looks not like a seesaw, that is because a normal seesaw for children, usually has the potential momentum comes from the gravity, present invention has the potential momentum comes from the combination of gravity and centrifugal force.

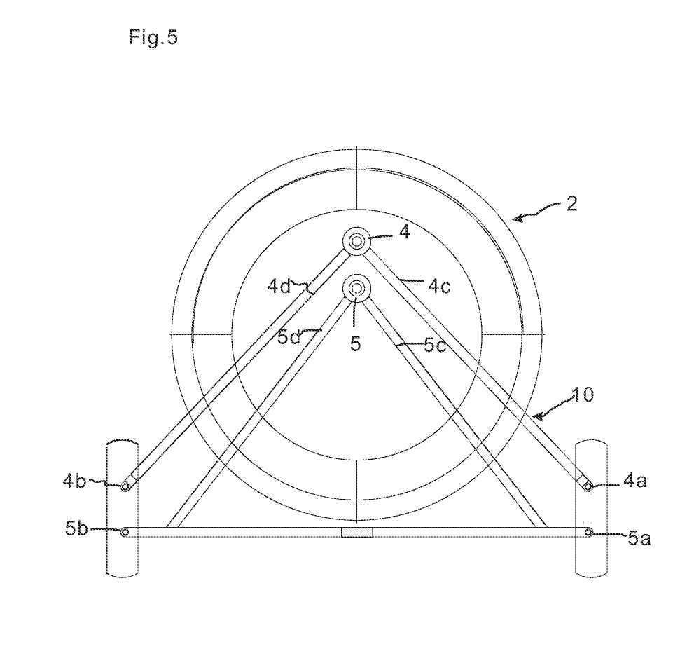

Apply the structure of FIG. 4 into a tilting vehicle, as shows on FIG. 5, a front or rear view of present invention, because either side of a four wheels tilting vehicle frame have the same frame structure, shows one side will be fit both. A front side or rear side of sub-frame 2 has at least two pivots 4,5, a main-frame 10 has two pairs of pivots (4a, 4b) (5a, 5b) parallel to the pivots of the sub-frame 4,5, and install at suspension systems or steering systems or any other structure which support the wheels, the pivots of sub-frame connected with the pivots of main-frame, via tie rods means 4c, 4d, 5c, 5d respectively at each wheel.

However, we don't have to use the tie rods means, any structure which could cause the pivot of sub-frame connect with the relative parallel pivot(s) of main-frame, for example pivots 4, 4a, 4b, into constant structure, and is a possible way.

Both front and rear sides of sub-frame 2, 3, will install the pivots (4, 5) (6.7) in two parallel axis 8, 9.

And, we claim each pivot means 4, 5, 6, 7 of the front side or rear side of sub-frame 2, 3, has only one pivot means mounted at each relative suspension or steering system or any other structure which support the wheel. As you knew, any structure, that is really easy to have more pivot(s) at the same axis, for example, to connect with the two pivots of upper or lower A-arm (control arm). We don't claim about this that is because: No matter how many pivots mounted at the same axis to do the same job, from the point of view of a well training mechanic engineer, there is only one pivot.

The subject matter is:

Both front side and rear side of sub-frame have at least two pivots means, install at the same number of pivots install at each suspension system, for example, the upper and lower control arms, or steering knuckle or any other structure which support the wheels on the parallel positions.

The pivots of main-frame 4a, 4b, 5a, 5b could be installing at the suspension system or steering knuckle or any other structure which support the wheels.

When the pivots of main-frame are in the steering knuckles, the pivots should be ball joints or universal joints or any other structure to provide universal pivot means, even if use the serve motor to steering the wheels via wires is a possible way.

Since we are talking about the steering system, where any one of the pivots of sub-frame 4, 5, 6, 7 is a preferable position to install the handle wheel through it.

Present invention can be install in tilting train, as everybody knew that a train do not have steering system, inventor focus on tilting frame work(s) only, the steering system and suspension system not shows here. However, the preferable structure of steering and suspension system is as similar as life-jet concept car of Mercedes, substantially.

In FIG. 4, the main-frame 15a has the pivots 18a, 18b on the ground, however, normal vehicle shall not be designed as FIG. 4 shows, thus, how is the tilting vehicle of FIG. 5 works, to apply the physical method of seesaw?

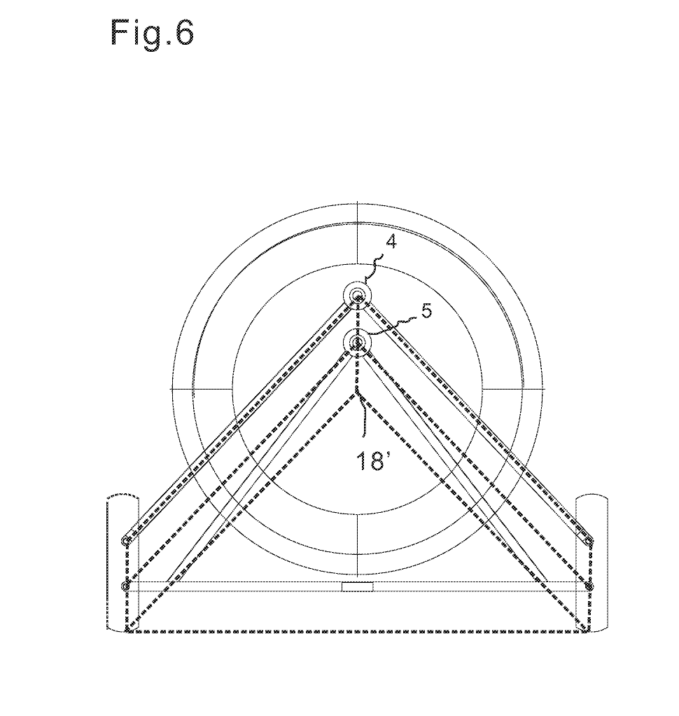

As shows on FIG. 6, combines the FIG. 4 in dotted lines with FIG. 5, below the pivot 5 is a virtual pivot 18′ as the pivot 18 of the seesaw in FIG. 4.

Engineers who design present tilting vehicle has to setup the potential momentum of the part of the sub-frame below the virtual pivot 18′ larger then the potential momentum of the part of the sub-frame above the virtual pivot 18′. Of course, the momentum of the part of the sub-frame above the virtual pivot 18′, including the momentum comes from the main-frame. And, the weight of passenger(s) and cargoes has to consider about.

This tilting vehicle frame, could install in three wheels vehicle, to install the single front or rear wheel, just move one wheel system of the front or rear side of the main-frame to the center, and remove the other(s).

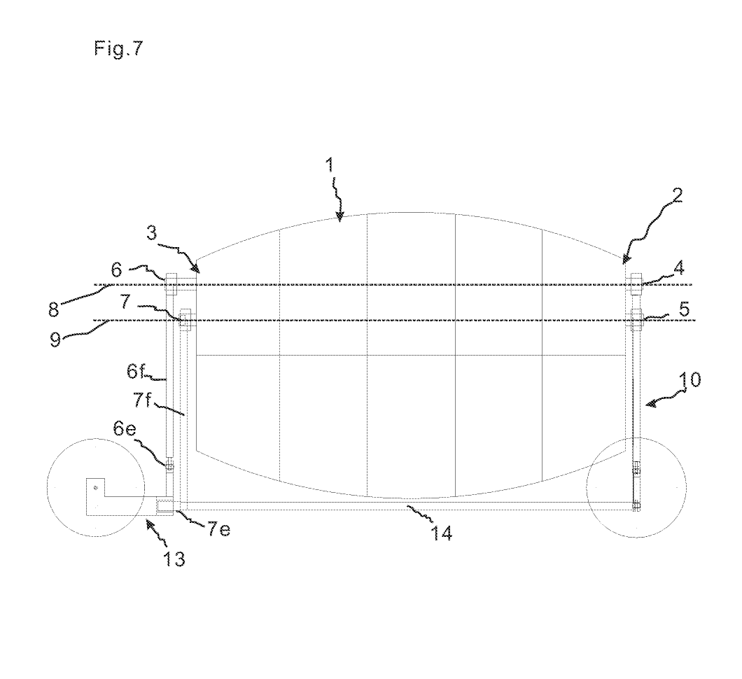

As shown on FIG. 7, the front or rear side 3 of sub-frame 1 has two pivots 6, 7, install at the sub-frame at the same axis 8, 9 of pivots 4, 5 which install at another side 2 of the sub-frame 1. The pivots 6, 7 of sub-frame connect with a single wheel system 13 of main-frame 10 at pivot means 6e, 7e via tie rods means 6f, 7f.

The single wheel side 3 of sub-frame 1, each pivot 6,7 has only one relative parallel pivot to connect, that's why in the claims, we declare: c. Said each pivot of said sub-frame connect with said relative parallel “pivot(s)” of said main-frame in constant structure.”, to claim both three wheels and over three wheels vehicle frame.

The FIG. 1 & FIG. 7 shows a rod means 14 connect the front and rear side of main-frame 10 together, the rod means 14 is not a necessary element, because in the light weight vehicle and the frame works are strong enough, the sub-frame can do the job of rod means 14. However, without the rod means 14, the main-frame 10 will be separate into two parts; this is why the second claim exists, to claim said main-frame 10 becomes two parts: a front main-frame and a rear main-frame. This is really easy to understand, do not need another drawing to explain.

As a conclusion, this is just like couple dancing, pas de deux,

What kind of shape that you need?

Which direction that you want to tilt?

All depend on,

How you cooperate with your partner, in what kind of partnership.

### SUMMARY

This invention separate vehicle into two parts, both could be suffer from the force of centrifugal and shifting outward to the direction of centrifugal force. However, because of these two parts are connected into together as two opposite sides of a seesaw via tie rods means and pivots means, after push and pull with each other, only the part with larger momentum shift outward, another part suffer from the momentum transfer from the tie rods means, has to shift inward.

From proper setting, could gain the shape of tilting inward. Hence, the major advantage of this invention is without any hydraulic or electric system to tilt.

Present invention cooperates with the centrifugal force to tilt, compare with the others which fight against with the centrifugal force.

That means, using the centrifugal force as the energy to tilt. From this, present invention gets benefits as follows:
1. Do not need any expensive hydraulic system and electric system—Cost down.
2. The hydraulic system and electric system spend too much space, save that for passengers and cargoes—Space larger.
3. Without the expensive hydraulic system and electric system, the weight down—Better fuel efficiency.
4. Centrifugal force comes from the Mother Nature, without any maintenances or errors as electric system could be.—Maintenance free.

What is claimed is:

1. A vehicle frame for at least three wheels vehicle, comprising
1. a sub-frame, having a front side and a rear side, both having at least two pivots means,
2. a main-frame, having a front side and a rear side, both having the same number of pivots means relative to said front or rear side of said sub-frame, which install at each steering system or suspension system or any other structure support the wheel or wheels, in relative parallel position, respectively.
3. Said each pivot of said sub-frame connect with said relative parallel pivot(s) of said main-frame in constant structure.

2. A vehicle frame for at least three wheels vehicle, comprising
1. a sub-frame, having a front and a rear side, both having at least two pivots means,
2. a front main-frame and a rear main-frame, having the same number of pivots means relative to said front or rear side of said sub-frame, which install at each wheel system or suspension system or any other structure which support the wheels, in relative parallel position, respectively.
3. Said each pivot of said sub-frame connect with each said relative parallel pivot(s) of said front or rear main-frame in constant structure.
